(19) United States
(12) Patent Application Publication
(10) Pub. No.: US 2006/0265578 A1
(43) Pub. Date: Nov. 23, 2006

(54) Detection of a sequencing error in the execution of a program

(75) Inventors: Jean-Louis Modave, Ottignies (BE); Ronny Van Keer, Hoeilaart (BE)

Correspondence Address: STMicroelectronics Inc.;c/o WOLF, GREENFIELD & SACKS, PC, Federal Reserve Plaza, 600 Atlantic Avenue, BOSTON, MA, 02210-2206, US

(73) Assignee: Proton World International N.V., Zaventem (BE)

(21) Appl. No.: 11/437,416

(22) Filed: May 19, 2006

(30) Foreign Application Priority Data
May 20, 2005 (FR) 05/51307

(51) Int. Cl. G06F 9/44

(52) U.S. Cl. 712/245

(57) ABSTRACT

The automatic control of the execution of a program by a microprocessor, including storing an initial state of a counter before execution of at least one instruction comprising the execution a given number of times of at least one same operation; on each execution of the operation, incrementing or decrementing the counter by a weight assigned to the operation; and at the end of the instruction, comparing the final state of the counter with an estimated value by increasing, respectively decreasing, its initial state by a multiple of the weight assigned to the operation corresponding to the normal number of executions of this operation in the instruction.

### BACKGROUND OF THE INVENTION

1. Field on the Invention

The present invention generally relates to the execution of programs (software codes) by a microprocessor. The present invention more specifically relates to the control of the integrity of a program during its execution, to check that it is executed with a normal sequencing.

2. Discussion of the Related Art

When a program is executed by a microprocessor, it is desirable to be able to detect that the normal sequencing of the program is respected. A modification in this operation may be incidental or voluntary and result, for example, from a computer virus or a hacking attempt consisting, more specifically, in fault injections into the program execution.

For example, a so-called trap fault injection attack may consist in the introduction of a disturbance capable of causing an unexpected jump in the program execution sequence (for example, by means of a disturbance of thermal, luminous, component supply, etc. type).

An attack by fault injection applied during the execution of an authentication algorithm may consist of having the program counter jump to cause a jump in the execution sequence and then exit a blocking (for example, an endless loop) caused by the algorithm as a consequence of a lack of authentication. An example of application of such an attack is the case of a processor having to decide whether or not a specific operation is authorized (for example, in the case of credit cards, the authorization of a bank transaction after authentication of the user).

An attack by fault injection applied during the execution of a ciphering or cryptography algorithm (DSA, RSA, DES, AES, etc.) may be used, as combined with an analysis of the (partial or full) results provided by the component (for example, by analysis of its power consumption) to discover secret quantities.

According to another aspect, a hacker attempts to modify the sequencing of a program on execution thereof to stop the application executed by the microprocessor (for example, contained in a smart card) to fraudulently extend a utilization period managed by the card (transportation ticket, for example). In this case, this amounts, sometimes to modifying the control order received by the card processor, sometimes to inserting abnormal control signals in sessions of communication with the card.

According to the application, the program to be protected is contained in a ROM written into upon manufacturing and that cannot be modified, or in a rewritable non-volatile memory, for example, a flash memory.

To protect the software code on execution thereof, a periodic checking of this code is generally provided based on an authentication key stored in a memory or in the integrated circuit, for example, on initial storage of the program or installation thereof. For example, a signature (application of an encryption algorithm to at least a portion of the software code) is calculated upon installation or writing of the program. This signature is then stored in or outside of the microcontroller. Then, on execution of the software code, the operating system recalculates a signature based on the same algorithm as that used for the generation of the initial signature. The current signature is then compared with the predetermined signature. A divergence between the two signatures means that the stored program has been modified and thus enables identifying a potential unwanted or incidental attack. An example of such an integrity check method is described in U.S. patent n°5442645, which is incorporated herein by reference.

A disadvantage of known solutions with signatures is that the integrity checking is static, that is, at the beginning of the program, it is checked whether the signature is or not authorized. Accordingly, such a protection system is inefficient in practice in case of a fault injection during the program execution.

Another known solution to control the execution of a program is to perform certain operations twice, to have a redundancy on the data to check the coherence between the two executions.

A common disadvantage of the above-discussed known techniques is that place significant demands on calculation resources. Accordingly, they are poorly adapted to low-power microcontrollers, as for example those available in smart cards.

### SUMMARY OF THE INVENTION

The present invention aims at overcoming all or part of the disadvantages of known solutions for controlling the execution of a program and, more specifically, at enabling dynamic checking, that is, a checking which detects the errors in the sequencing of a program on execution thereof.

The present invention also aims at avoiding that the result of a signature calculation to be known in advance by the microcontroller.

The present invention also aims at requiring no authentication signature updating on each updating of the software code to be protected.

The present invention also aims at being compatible with an execution on a smart card type microcontroller of limited power.

The present invention also aims, according to its preferred aspect, at making the checking independent from the actual program by requiring no programming intervention on the error detection method in case of a modification in the program to be monitored.

To achieve all or part of these and other objects, the present invention provides a method of automatic control of the execution of a program by a microprocessor, comprising:

storing an initial state of a counter before execution of at least one instruction comprising the execution a given number of times of at least one same operation;

on each execution of the operation, incrementing or decrementing the counter by a weight assigned to the operation; and

at the end of the instruction, comparing the final state of the counter with an estimated value by increasing, respectively decreasing, its initial state by a multiple of the weight assigned to the operation corresponding to the normal number of executions of this operation in the instruction.

According to an embodiment of the present invention, said estimated value is obtained independently from the execution of the instruction.

According to an embodiment of the present invention, the weights assigned to different operations are selected to be relatively prime numbers.

According to an embodiment of the present invention, said counter is not initialized at the beginning of an instruction.

According to an embodiment of the present invention, the number of executions of the operation corresponds to the number of bytes to be processed by the operation to execute the instruction on a word of several bytes.

The present invention also provides a microcontroller comprising at least one microprocessor.

The present invention also provides a smart card comprising a microcontroller.

The foregoing objects, features, and advantages of the present invention, as well as others, will be discussed in detail in the following non-limiting description of specific embodiments in connection with the accompanying drawings.

### BRIEF DESCRIPTION OF THE DRAWINGS

FIG. 1 very schematically shows in the form of blocks an example of a microcontroller to which the present invention more specifically applies;

FIG. 2 very schematically illustrates in the form of blocks an embodiment of the error detection method in the execution of a program according to the present invention;

FIG. 3 is a simplified flowchart of a first example of implementation of the method illustrated in FIG. 2; and

FIG. 4 is a simplified flowchart of a second example of implementation of the method of FIG. 2.

### DETAILED DESCRIPTION

The same elements have been designated with the same reference numerals in the different drawings.° For clarity, only those elements and steps which are necessary to the understanding of the present invention have been shown and will be described hereafter. In particular, the operators or instructions involved by the implementation of the present invention have not been described in detail, the present invention applying whatever the type of operators or instructions. Further, the components necessary to the execution of a program, be it for a software implementation or by means of a wired logic state machine, have been described in detail, their forming using conventional elements.

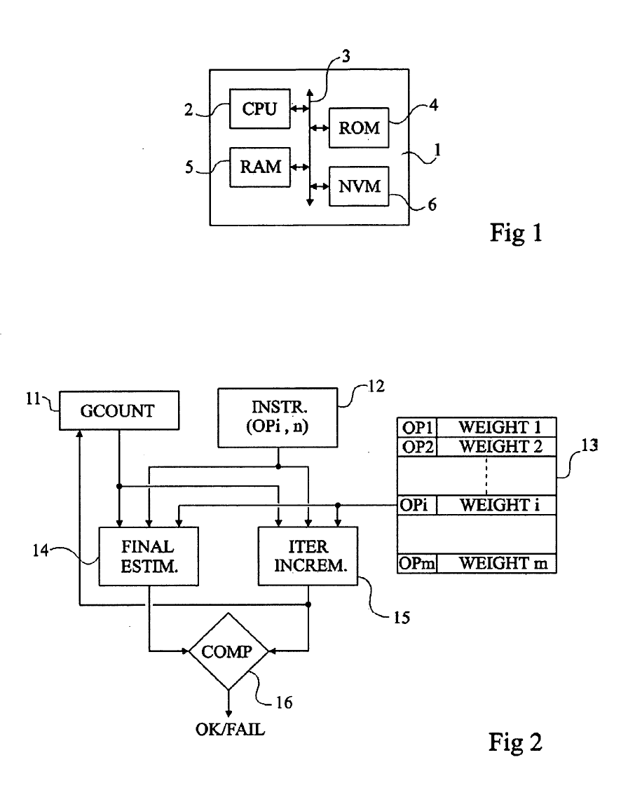

FIG. 1 very schematically shows in the form of blocks a simplified embodiment of a microcontroller 1 of smart card type to which the present invention more specifically applies. Such a microcontroller 1 comprises a central processing unit 2 (CPU) communicating via one or several address, data, and control bus(es) 3 with different memories. The microcontroller comprises at least one memory 4 (for example, a ROM or a flash memory) for storing programs to be executed, a RAM 5 used during execution of the programs and, optionally, a non-volatile rewritable memory (NVM) 6. Chip 1 also comprises inputs/outputs (not shown) towards the outside, be it in the form of contacts and/or of a communication antenna.

The present invention will be described hereafter in relation with an example of application to smart cards. It should however be noted that it more generally applies to any electronic component containing a program execution microcontroller, be the memories integrated or not with the microprocessor.

A feature of an embodiment of the present invention is to assign to all or part of the operations executed by the microprocessor different respective weights. “Weight” is used to designate a number which will be used as an increment or a decrement for a counter. “Operation” will be used to designate either an operation of minimum granularity, that is, an elementary operation executed, during an instruction, over a number of bits linked to the microcontroller capacity (for example, a same operation executed on bytes of a word of several bytes in the case of an 8-bit processor), or operations themselves formed of several elementary operations. The operations may be arithmetical, logic, or access operations (reading from, writing into a register). “Instruction” is used to designate an order to execute at least one operation a given number of times.

Another feature of an embodiment of the present invention is to use a counter, an image of which is incremented or decremented, independently from the execution of an instruction but according to the weight assigned to the operations executed in the instruction and to the normal number of executions, and to iteratively increment or decrement the counter along the execution of the operations to compare the final state of the counter obtained at the end of the instructions with the expected value calculated from the initial image. The calculation of the expected value is performed either at the beginning of the execution, or during, or after, but without being assigned at each go, conversely to the iterative increment along the execution.

The initial state of the counter is of no importance. It is thus a limited counter which runs in a loop between maximum and minimum values. These values preferably correspond to the limiting values of the possible counting range of the counter.

Preferably, the respective weights assigned to the operations are selected to avoid collisions between obtained values, that is, to avoid for the weight of an operation of a first type multiplied by its number of executions in an instruction to be equal to the weight of an operation of a second type by another number of executions. For example, the weights are selected to be relatively prime numbers of high values (greater than 200). The collision probability is then considered as sufficiently low.

FIG. 2 illustrates, in a simplified view in the form of blocks, an embodiment of the method for controlling the execution of a program according to the present invention. This diagram is functional and does not necessarily represent the implemented hardware elements, where said elements can at least partially correspond to central processing unit 2 executing a software code.

A value GCOUNT of a first counter is stored in a storage element 11. It may either be an area of a RAM (5, FIG. 1), of a non-volatile rewritable memory, yet of a dedicated register of the microcontroller. Value GCOUNT varies in a loop without requiring to be reinitialized at specific times. Of course, if this value is stored in the RAM, it will be reinitialized on each cutting off of the supply of the actual microcontroller 1. In the case where it is stored in non-volatile rewritable memory 6, it will for example be initialized at the first program start or periodically, but this has no incidence upon the operation of the present invention, as will be better understood hereafter.

Each time central processing unit 2 calls for the execution of an instruction (block 12, INSTR. (OPi, n)), a weight WEIGHTi (i, ranging between 1 and m) of operation OPi executed by this instruction is extracted from a non-volatilely stored table 13. The instruction also defines number n (greater than or equal to 1) of executions of operation OPi, for example, after a division in bytes of a word over several bytes. Table 13 may be stored in the ROM on manufacturing but will preferably be stored in rewritable memory 6 to enable updating thereof.

In the case where all the operations implemented by the microprocessor are not taken into account by the control of the present invention, the m operations, the execution of which is monitored, may be modified according to the application. It is enough for the program to check, at each instruction beginning, whether it is an operation to be monitored (contained in table 13) and to then implement the counting steps which will be described hereafter.

Before the beginning of the execution of the instruction, value GCOUNT contained in register 11 is read by central processing unit 2 and is stored (for example, in an intermediary register) to estimate the expected final value (block 14, FINAL ESTIM.) based on weight WEIGHTi of operation OPi and on number n of executions of this operation in the instruction. The calculation of this final estimate (increment or decrement by n*WEIGHTi) is performed any time with respect to the instruction execution (before, during, or after) while however avoiding an iterative calculation along the execution of the operations.

On execution of the instruction, that is, of the n identical operations OPi, current value GCOUNT contained in register 11 is iteratively incremented (or decremented) by weight WEIGHTi on each execution (block 15, ITER INCREM.).

Once the instruction is over and the final estimate has been calculated, the two obtained values are compared (block 16, COMP). In case of an identity between the two values, it is considered that the instruction has executed with no disturbance (OK) in its sequence. In the opposite case, this means an error in the program execution (FAIL). The fact of calculating the final estimate independently from the iterative execution of the instruction prevents the two results from being identical in case of a disturbance during this execution.

Preferably, storage register 11 of general counter GCOUNT is updated on each iteration (block 15) of the instruction, which decreases to two the number of registers necessary to contain the two counting values to be compared. As a variation, an additional intermediary register may be used to contain the iteratively updated value. Such will for example be the case if the value of a counter used, besides, for other purposes (for example, the program counter, an access counter, etc.), is used.

According to a preferred embodiment of the present invention, the comparison between the expected result and that obtained by execution of the instruction is performed by the microcontroller operating system, either at the end of each instruction, or periodically, provided that this time corresponds to the end of the execution of an instruction. The operations preferably correspond to the elementary operations capable of being executed by the microcontroller.

Several controls may be combined at different levels in the execution of a same software code. For example, a checking of the correct execution of several successive instructions may be combined with a checking of the individual executions of these instructions.

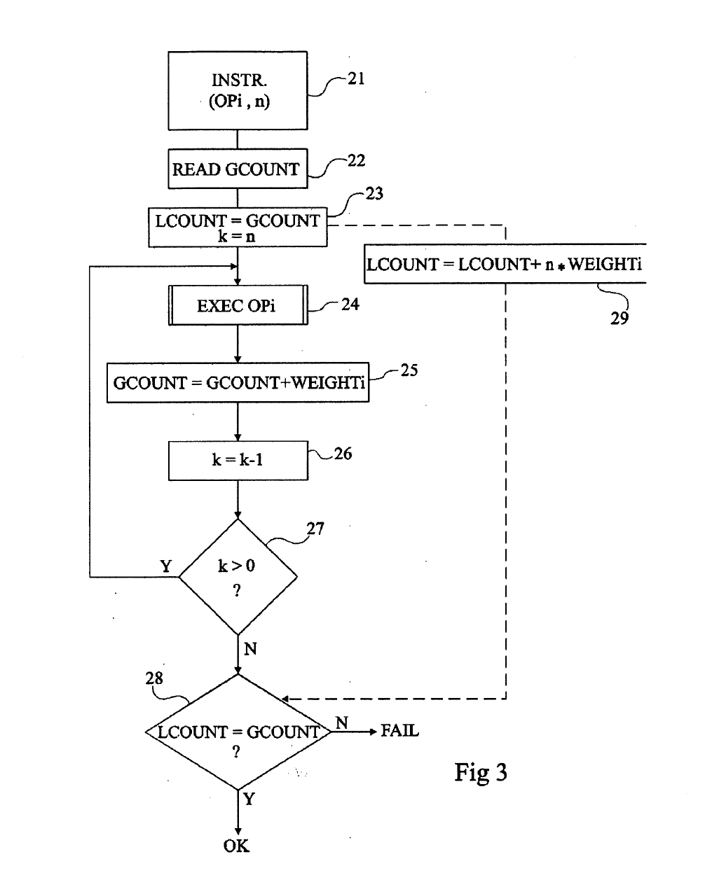

FIG. 3 is a flowchart schematically illustrating a first example of execution of an instruction by implementation of the method illustrated in FIG. 2. The execution of an instruction INSTR executing an operation OPi n times (block 21, INSTR (OPi, n)) is assumed. It is started (block 22, READ GCOUNT) by reading the counter state to store its value (block 23, LCOUNT=GCOUNT) in an intermediary register intended to contain the final estimate of the state to be reached by the counter. In this same step, a loop index k is initialized as being equal to number n of operations OPi to be executed. It is then entered into a loop, where each iteration of rank k comprises the execution of operation OPi (block 24, EXEC OPi), followed by the incrementation of counter GCOUNT by the weight of an execution (block 25, GCOUNT=GCOUNT+WEIGHTi), before decrementing index k (block 26, k=k−1). Each iteration ends with a test (block 27, k>0?) conditioning the loop output. As long as the n operations have not been executed (output Y of block 27), it is returned to block 24 for the next execution of operation OPi. As a variation, any loop with n iterations may replace index k initialized at value n (for example, an inverse initialization at a zero or unity value, then an incrementation to reach value n−1 or n).

Once all the operations of the instruction have been executed (output N of block 27), value GCOUNT is compared (block 28, LCOUNT=GCOUNT ?) with value LCOUNT, updated separately (block 29, LCOUNT=LCOUNT+n*WEIGHTi), to obtain the expected final estimate. The fact for this estimate to be performed independently from operation OPi is illustrated in FIG. 3 by a dotted line. In case of an identity between the counter state and the expected state (output Y of block 28), it is considered that the execution of the instruction has not been incidentally or voluntarily diverted (OK). In the opposite case, the sequencing error detection method provides a signal FAIL (for example, a flag bit) indicative of an error risk in the instruction sequencing.

The action to be taken after such a detection most often is an error procedure. In practice, in the case of a smart card, such a procedure includes muting the smart card. However, any other conventional procedure implemented in case of an error detection in the execution of a program may be used.

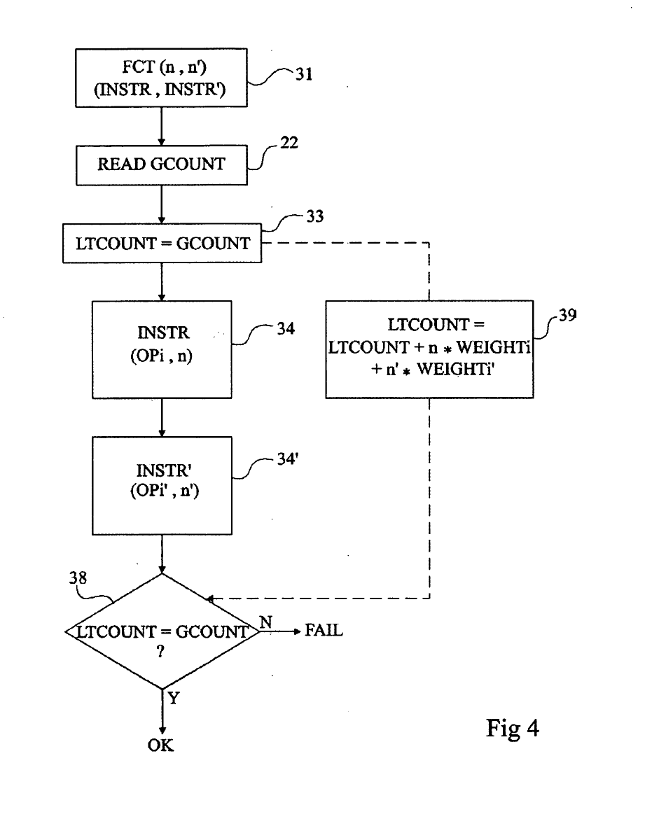

FIG. 4 is a flowchart illustrating a second example of implementation of the present invention in which a function FCT of several instructions (for example, two instructions INSTR and INSTR′ respectively executing n operations OPi and n′ operations OPi′) is monitored by the execution control method.

On calling of the function (block 31, FCT (n, n′) (INSTR, INSTR′)), the general counter of value GCOUNT is read from (block 22, READ GCOUNT). Then, an intermediary register is initialized with the value of this counter (block 33, LTCOUNT=GCOUNT). Value LTCOUNT is used as a base for a final estimate LTCOUNT taking into account both instructions INSTR and INSTR′ (block 39, LTCOUNT=LTCOUNT+n*WEIGHTi+n′*WEIGHTi′).

Instructions INSTR and INSTR′ are then successively executed (block 34, INSTR (OPi, n) and block 34′ INSTR′ (OPi′, n′) by reproducing the flowchart of FIG. 3 for each of the instructions. Accordingly, an additional intermediary register is used for value LCOUNT and detects a possible non-respecting of the sequencing within each instruction.

At the end of the second instruction, the content of general counter GCOUNT is compared (block 38, LTCOUNT=GCOUNT?) with value LTCOUNT independently updated in block 39. This test results in a decision relative to the presence (output N, FAIL, of block 38) or the absence (output Y, OK, of block 38) of an error risk.

As a variation, the tests (28, FIG. 3) are not implemented in blocks 34 and 34′ and a single final test is performed (block 38).

According to another variation, the control method is implemented at a still higher level (for example, controls of several functions, themselves of several instructions of several operations). If the controls of the different levels are intricate (FIG. 4), this amounts to adjusting a control level. If only the upper level controls are performed, this amounts to considering an operation of a level higher than that of the elementary operations.

An advantage of the present invention is that it enables dynamically detecting a voluntary or incidental fault in the execution of a program.

Another advantage of the present invention is that its implementation requires but little resources. Indeed, it is enough to have a table of correspondence of the weights assigned to the different operations (this table may even be omitted if the increments/decrements are directly written into the program), and at least two storage spaces for the respective values GCOUNT and LCOUNT of the counter.

Another advantage of the present invention is that it is not necessary to know in advance the value to be reached by the counter. Only the increment or decrement (weight of each: operation) needs being known. This is a significant difference with respect to a signature calculation in which the expected value of the signature needs being known from the origin.

Another advantage of the present invention is that the counter does not need to be reinitialized at specific periods and can run in a loop.

Another advantage resulting therefrom is that the checking program does not need to be modified in case of an updating of the program to be monitored provided that the latter calls the checking program at the beginning of the instructions to be monitored by providing thereto the operation type and its number of executions. Accordingly, the method of the present invention is independent from the program to be monitored.

Of course, the present invention is likely to have various alterations, modifications, and improvements which will readily occur to those skilled in the art. In particular, the selection of the weights (increments/decrements) applied to the different operations are within the abilities of those skilled in the art according to the application, based on the functional indications given hereabove. Further, the selection of the operations to be monitored in the case where not all of them are taken into account by the implementation of the present invention is also within the abilities of those skilled in the art. Finally, the practical implementation of the present invention by software means to execute the checking method is within the abilities of those skilled in the art and uses usual programming notions.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A method of automatic control of the execution of a program by a microprocessor, comprising:
storing an initial state of a counter before execution of at least one instruction comprising the execution a given number of times of at least one same operation;
on each execution of the operation, incrementing or decrementing the counter by a weight assigned to the operation; and
at the end of the instruction, comparing the final state of the counter with an estimated value by increasing, respectively decreasing, its initial state by a multiple of the weight assigned to the operation corresponding to the normal number of executions of this operation in the instruction.

2. The method of claim 1, wherein said estimated value is obtained independently from the execution of the instruction.

3. The method of claim 1, wherein the weights assigned to different operations are selected to be relatively prime numbers.

4. The method of claim 1,. wherein said counter is not initialized at the beginning of an instruction.

5. The method of claim 1, wherein the number of executions of the operation corresponds to the number of bytes to be processed by the operation to execute the instruction on a word of several bytes.

6. A microcontroller comprising at least one microprocessor, comprising means for executing the method of claim 1.

7. A smart card comprising the microcontroller of claim 6.
